(19) United States
(12) Patent Application Publication
(10) Pub. No.: US 2008/0259236 A1
(43) Pub. Date: Oct. 23, 2008

(54) ELECTROSTATIC DISSIPATIVE STAGE AND EFFECTORS FOR USE IN FORMING LCD PRODUCTS

(75) Inventors: Oh-Hun Kwon, Westborough, MA (US); Steve D. Hartline, Shrewsbury, MA (US); Raymond H. Bryden, Holden, MA (US)

Correspondence Address: LARSON NEWMAN ABEL POLANSKY & WHITE, LLP, 5914 WEST COURTYARD DRIVE, SUITE 200, AUSTIN, TX, 78730, US

(73) Assignee: SAINT-GOBAIN CERAMICS & PLASTICS, INC., Worcester, MA (US)

(21) Appl. No.: 12/101,686

(22) Filed: Apr. 11, 2008

Related U.S. Application Data
(60) Provisional application No. 60/911,817, filed on Apr. 13, 2007.

(51) Int. Cl. G02F 1/133; B05D 5/00; B05D 5/12

(52) U.S. Cl. 349/40; 427/166; 427/168

(57) ABSTRACT

A process for producing a liquid crystal display (LCD) is provided that includes placing a glass substrate on a stage, and subjecting the glass substrate to at least one processing operation of a plurality of processing operations for forming an array of electronic devices on the glass substrate. The stage being electrostatic discharge dissipative and having a surface portion that has a volume resistivity (Rᵥ) within a range between about 1E5 Ωcm and about 1E11 Ωcm.

### CROSS-REFERENCE TO RELATED APPLICATION(S)

The following disclosure is a non-provisional application which claims priority to U.S. Provisional Application No. 60/911,817 filed Apr. 13, 2007, entitled “Electrostatic Dissipative Stage for Use in Forming LCD Products” and having named inventors Oh-Hun Kwon, Steve D. Hartline, Xiaofeng Tang, and Qiang Zhao, which application is incorporated by reference herein in its entirety.

### BACKGROUND

1. Field of the Disclosure

This disclosure is directed to stages and effectors for holding and manipulating glass substrates, and is particularly directed to processes for forming LCD displays utilizing such stages and effectors.

2. Description of the Related Art

The manufacture of liquid crystal displays (LCDs) has becoming increasingly daunting as the industry continues to demand displays having improved features, such as greater size, better resolution, brighter colors, greater contrast, improved viewing angles, and longer viewing lives. Because of these demands, the industry has been required to improve the components and processes for forming the components within the LCDs. Notably, the industry has had to achieve the creation of thin film transistors (TFTs) and particularly arrays of thin film transistors that rival those of the semiconductor industry in forming integrated circuitry.

The formation of thin film transistors is an exacting process requiring creation of nanometer-sized films that are deposited in particular locations on a glass substrate. Ultimately, the series of deposited layers work together to form an array of transistors that facilitate controlling individual pixels on the screen and thus helping to deliver the image to the viewer. However, as it is well known, the formation of such TFT arrays is a highly technical endeavor requiring state of the art processing operations such as the formation or removal of nanometer-sized films in a controlled environment. Notably, a major concern of formation of a TFT array includes process induced damage such as for example, contamination. Because the process is so demanding, the current industry production efficiency for producing LCD panels is between 70% and 80%.

Accordingly, the industry continues to demand improved articles and processes for forming LCD panels that will improve the production efficiency, throughput, and the quality of the LCD panels formed.

### SUMMARY

According to one aspect a process for producing a liquid crystal display (LCD) is disclosed which includes placing a glass substrate on a stage, and subjecting the glass substrate to at least one processing operation of a plurality of processing operations for forming an array of electronic devices on the glass substrate. The stage being electrostatic discharge (ESD) dissipative and having a surface portion that has a volume resistivity (Rᵥ) within a range between about 1E5 Ωcm and about 1E11 Ωcm; and

According to another aspect, a LCD stage is disclosed which includes a body comprising a surface portion, the surface portion being an electrostatic discharge (ESD) dissipative material having a volume resistivity (Rᵥ) within a range between about 1E5 Ωcm and about 1E11 Ωcm.

According to another aspect, a LCD glass substrate effector is disclosed that includes a body comprising an arm portion extending from the body, wherein the body has a surface portion being an electrostatic discharge (ESD) dissipative material having a volume resistivity (Rᵥ) within a range between about 1E5 Ωcm and about 1E11 Ωcm.

### BRIEF DESCRIPTION OF THE DRAWINGS

The present disclosure may be better understood, and its numerous features and advantages made apparent to those skilled in the art by referencing the accompanying drawings.

FIG. 1A includes an illustration of a cross-sectional view of a workpiece including a portion of a glass substrate and a stage in preparation for forming a TFT array on the glass substrate according to one embodiment.

FIG. 1B is a cross-sectional view of the workpiece illustrated in FIG. 1A after forming electrodes according to one embodiment.

FIG. 1C is a cross-sectional view of the workpiece illustrated in FIG. 1B after forming a dielectric layer according to one embodiment.

FIG. 1D is a cross-sectional view of the workpiece illustrated in FIG. 1C after forming an intermediate semiconductive layer portion according to one embodiment.

FIG. 1E is a cross-sectional view of the workpiece illustrated in FIG. 1D after forming a top semiconductive layer portion according to one embodiment.

FIG. 1F is a cross-sectional view of the workpiece illustrated in FIG. 1E after forming a transparent electrode layer portion according to one embodiment.

FIG. 1G is a cross-sectional view of the workpiece illustrated in FIG. 1E after forming source/drain layer portions according to one embodiment.

FIG. 1H is a cross-sectional view of the workpiece illustrated in FIG. 1G after forming a passivation layer portion according to one embodiment.

FIG. 2 is a cross-sectional diagram of a portion of a LCD panel according to one embodiment.

FIG. 3 is a cross-sectional diagram of a portion of a stage of effector according to one embodiment.

FIG. 4 is a cross-sectional diagram of a portion of a stage or effector according to one embodiment.

FIG. 5 is a top view of a stage having a patterned working surface according to one embodiment.

FIG. 6 is a cross-sectional view of a portion of a stage having raised portions defining a working surface according to one embodiment.

FIG. 7 is a perspective view of a LCD glass substrate effector in accordance with one embodiment.

FIG. 8 is a plot of volume resistivity measured at an applied voltage of 1V for 17 samples in accordance with an embodiment.

FIG. 9 is a plot of volume resistivity measured at an applied voltage of 10 V for 17 samples in accordance with an embodiment.

FIG. 10 is a plot of volume resistivity measured at an applied voltage of 100 V for 17 samples in accordance with an embodiment.

The use of the same reference symbols in different drawings indicates similar or identical items.

### DESCRIPTION OF THE PREFERRED EMBODIMENT(S)

In general, the formation of an LCD panel includes the formation of an array of thin-film transistors (TFT). The formation of a TFT array for a LCD panel is similar to the process of forming transistors in semiconductor devices, and as such, requires a highly controlled processing environment. Accordingly, forming a TFT array generally includes a series of processing operations that may include repetition of certain processes such as cleaning, masking, deposition, and etching.

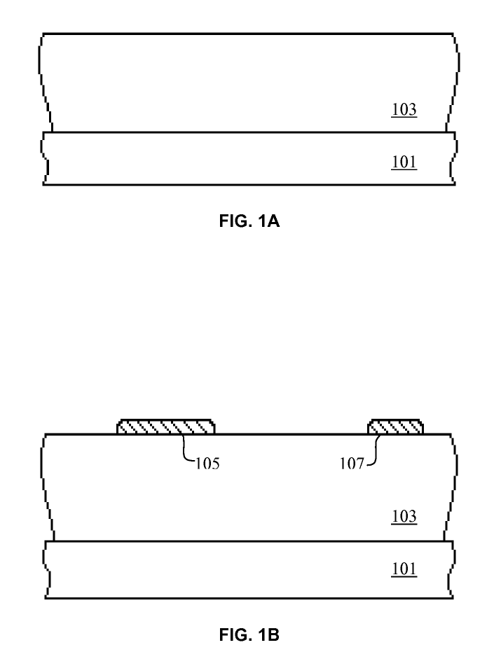

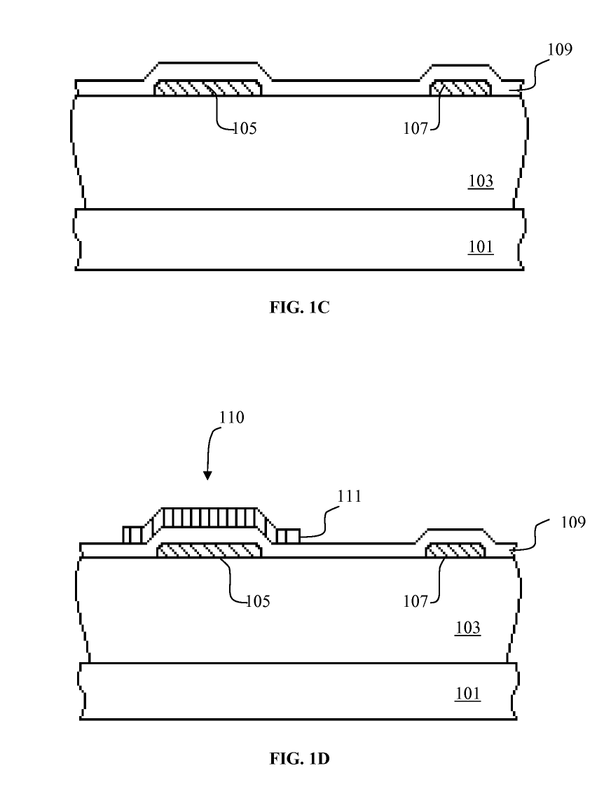

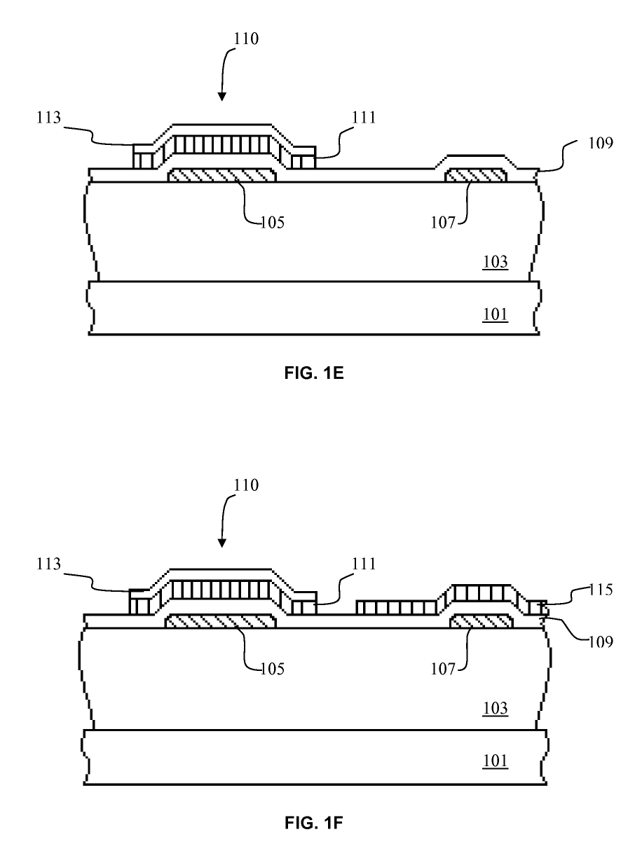

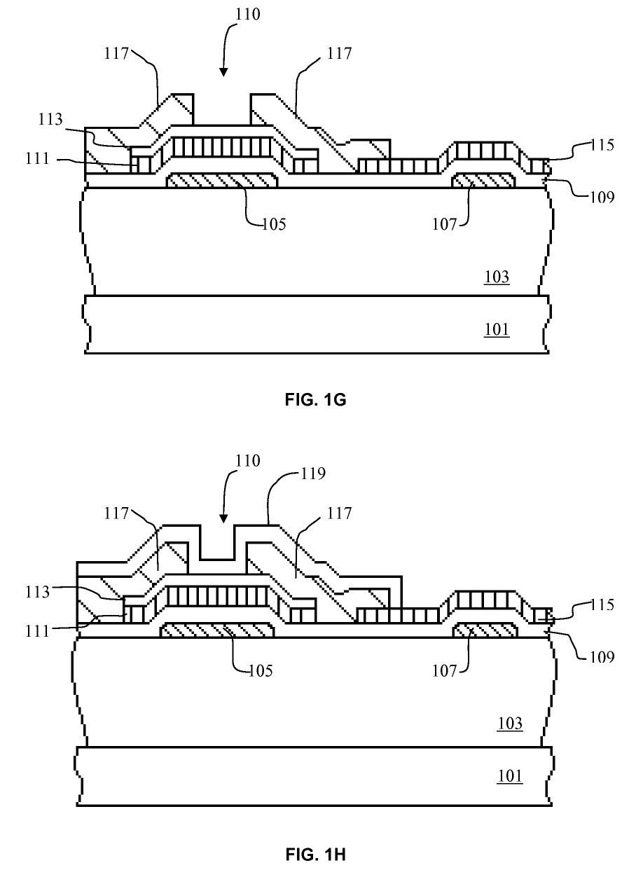

As illustrated in FIG. 1A, the process of forming TFT array is initiated by placing a glass substrate 103 upon a stage 101. Typically, the process of forming LCD panels is not done on a panel-by-panel basis, but rather the process is completed on a sheet of glass which is larger than the intended LCD panel. This sheet of glass can be sectioned into smaller individual LCD panels after formation of the TFT array. Sectioning is completed after formation of the TFT array for ease of processing, consistency, and efficiency.

According to one embodiment, the glass substrate 103 can be rectangular, having a length, width, and thickness. The glass substrates are generally large, having a length of not less than about 0.5 meters. Still, the length of such glass substrates may be greater, such as not less than about 0.75 m, not less than about 1.0 m, or even not less than about 2.0 m, oftentimes within a range between about 1.0 m and about 5.0 m. The width is generally comparable to the length, such that the substrates generally have a width of not less than about 0.5 m. In other embodiments, the width of the substrates is greater, such as not less than about 0.75 m, not less than about 1.0 m, or even not less than about 1.5 m. The width of the substrates is generally within a range between about 0.5 m and about 5.0 m.

The glass substrates generally have a thickness of not greater than about 3.0 cm. In one embodiment, the thickness is less, such as not greater than about 2.0 cm, or even not greater than about 1.0 mm. Still, the thickness of the glass substrates is limited, and is typically not less than about 1.0 mm.

It will be appreciated that the process of producing most of the glass for windows (i.e., the float process) is not sufficient for producing glass substrates for LCD panels. One particular method of forming glass substrates for LCD panels is a fusion process where molten glass flows into a trough, or isopipes. Upon filling the isopipe, the molten glass flows over opposing sides of the isopipe, which is appropriately shaped such that the streams of glass fuse together and cool to form high quality glass substrates. As will be appreciated, the glass substrates generally have particular properties such as high thermal stability, and reduced levels of particular elements, such as free alkali metals and halides.

The stage 101 is provided as a support surface of the glass substrate during processing of the glass substrate. Accordingly, the stage 101 must be of comparable size to the size of the glass substrates being processed. As such, the stage 101 can have a rectangular shape, having a length and width as described above with respect to the glass substrate. Generally, the length of the stage is not less than about 0.5 meters. Still, the length of the stage may be greater, such as not less than about 0.75 m, not less than about 1.0 m, or even not less than about 2.0 m. Generally, the length of the stage is limited, such that it is not greater than about 10 m, and particularly within a range between about 1.0 m and about 5.0 m. As such, the width of the stage can be comparable, such that the width is not less than about 0.5 m. In other embodiments, the width of the stage is greater, such as not less than about 0.75 m, not less than about 1.0 m, or even not less than about 1.5 m. The width of the stage is generally limited such that it is not greater than about 10 m and particularly within a range between about 0.5 m and about 5.0 m.

The thickness of the stage is less than the other dimensions, but generally not less than about 0.5 cm. According to one embodiment, the thickness of the stage is not less than about 0.8 cm, or even not less than about 1.0 cm. In particular, the thickness of the stage is typically within a range between about 1.0 cm and about 20 cm.

After placing the glass substrate on the stage, the processes for forming the TFT array can be initiated. In general, the glass substrate will be subjected to a plurality of processing operations, the purpose of which is to form an array of transistors, and oftentimes other electronic components, which can include for example, the electronics controlling the pixels. While transistors can have a variety of designs, the basic components are the same, and as such, formation of a transistor generally includes formation of gate electrode regions, dielectric regions, semiconducting regions, and source/drain regions and properly interconnecting each of these regions. Moreover, it will be appreciated that there are many designs for transistors, and accordingly the interconnection and placement of the regions can be changed. The following process is directed to forming a bottom gate transistor, that is the gate electrode is formed directly on the glass substrate, but it will be appreciated that other transistor designs are possible.

The process of forming the TFT array for a bottom gate designed transistor is initiated by forming a patterned array of gate electrodes and bus lines. As such, referring to FIG. 1B, a cross-sectional view of the workpiece of FIG. 1A is illustrated after forming electrodes 105 and 107. According to a particular embodiment, electrode 105 is a gate electrode and electrode 107 is a capacitor electrode. Generally, formation of the electrodes 105 and 107 is facilitated by first forming a patterned mask layer and then forming the electrodes in the voids of the patterned mask layer. Typically the patterned mask layer is a soft mask, such as a patterned mask layer formed via photolithography.

According to one embodiment, the electrodes 105 and 107 (and any bus lines) are formed by a deposition process. In particular, the deposition process can include a thin film deposition process, such as chemical vapor deposition (CVD) process, physical vapor deposition (PVD) (e.g., sputtering), atomic layer deposition (ALD), or any combination thereof. In one particular embodiment, the gate electrodes and gate bus lines are formed via plasma-enhanced CVD (PECVD).

The deposited electrodes and bus lines can be quite thin, and may include a plurality of thin films. Suitable thicknesses for the gate electrodes and bus lines can be on the order of submicron, such as not greater than about 500 nm, and particularly within a range between about 100 nm to about 300 nm.

The gate electrodes and bus lines can include a conductive material, such as a metal or metal alloy. Suitable metals can include aluminum, chromium, tantalum, tungsten, or alloys thereof. Certain TFT arrays may include other components, such as storage-capacitors, and as such, the extra components will likely utilize electrodes which can be formed during this process as well.

Referring to FIG. 1C, a dielectric layer 109 is formed over the surface of the substrate and particularly over the electrodes 105 and 107. Formation of the dielectric layer 109 is generally undertaken to facilitate the appropriate capacitance and electronic responses between the gate electrode the semiconducting layers. In particular, the forming the dielectric layer 109 can include a deposition process, such as a thin film deposition process, and particularly a chemical vapor deposition (CVD) process, physical vapor deposition (PVD) (e.g., sputtering), atomic layer deposition (ALD), or any combination thereof. In one particular embodiment, the dielectric layer 109 is formed via plasma-enhanced CVD (PECVD).

In one such embodiment, the dielectric layer 109 includes a dielectric material, having a dielectric constant of greater than about 2.0. According to one embodiment, the dielectric layer 109 includes a material having a dielectric constant of not less than about 4, such as not less than about 6, or even, not less than about 8. In one embodiment, the dielectric layer 109 includes a nitride or an oxide, or a combination thereof. Suitable nitrides can include silicon nitride (e.g., SiNₓ), which is directly deposited over the gate electrodes. Other embodiments utilize an oxynitride, such as SiOₓN_{y}. Generally, the dielectric layer 109 has a thickness of not greater than about 600 nm, and particularly within a range between about 200 nm and about 500 nm.

Referring to FIG. 1D, a cross-sectional view of the workpiece of FIG. is illustrated after forming a portion of the semiconducting region 110. Notably, formation of the semiconducting regions 110 can include a masking and patterning step such that the semiconducting regions are properly placed and deposited in relation to the gate electrodes, bus lines, and other electrodes. In particular, the forming the intermediate layer 111 can include a deposition process, such as a thin film deposition process, and particularly a chemical vapor deposition (CVD) process, physical vapor deposition (PVD) (e.g., sputtering), atomic layer deposition (ALD), or any combination thereof. In one particular embodiment, the intermediate layer is formed via plasma-enhanced CVD (PECVD).

The intermediate layer 111 generally includes a semiconducting material. The intermediate layer 111 includes a semiconductor material such as silicon, germanium, carbon, another semiconductor material, such as a III-V or a II-VI material, or any combination thereof. According to a particular embodiment, the intermediate layer 111 includes silicon, and particularly amorphous silicon (a-Si). The intermediate layer 111 can be undoped, or alternatively the intermediate layer 111 can be doped. In another embodiment, the intermediate layer 111 includes either fully or partially depleted n-type active semiconductor region, p-type active semiconductor region, or any combination thereof. The intermediate layer 111 has a substantially uniform thickness, generally having an average thickness of not greater than about 500 nm, and particularly within a range of about 50 nm to about 400 nm.

In further reference to the semiconducting region, FIG. 1E illustrates a cross-sectional view of the workpiece of FIG. 1D after forming a top semiconducting layer 113 overlying the intermediate layer 111. In one embodiment, the top semiconducting layer 113 is formed via a deposition process, such as a thin film deposition process, and particularly using chemical vapor deposition (CVD), physical vapor deposition (PVD) (e.g., sputtering), atomic layer deposition (ALD), or any combination thereof. In one particular embodiment, the top semiconducting layer 113 is formed via plasma-enhanced CVD (PECVD).

The top semiconducting layer 113 can include a semiconducting material, such as silicon. According to one embodiment, the top semiconducting layer 113 includes a doped semiconducting material, such as a doped amorphous silicon, and particularly n-type doped amorphous silicon. Generally, the top semiconducting layer 113 has a thickness of not greater than about 3000 Angstroms, and particularly within a range between about 200 Angstroms and about 1000 Angstroms.

As will be appreciated, fewer or greater number of layers can be included in the semiconducting region 110, depending upon the intended transistors being formed. As such, the semiconducting region 110 typically includes at least one layer including silicon, such as an amorphous silicon, polysilicon, or silicon nitride, p-type doped silicon, n-type doped silicon, and more typically any combination of layers including such materials. In forming a series of layers, the process can further include a series of etching steps to properly remove portions of layers. Generally, the semiconducting region typically has a thickness on the order of about 300 nm to about 900 nm.

In addition to forming a semiconducting region 110, the process of forming a TFT can include formation of a pixel region. Referring to FIG. 1F, a cross-sectional view of the workpiece of FIG. 1E is illustrated after forming a transparent electrode 115. It will be appreciated that the formation of a transparent electrode can be undertaken during the formation of the semiconducting region 110, and particularly during the formation of the multiple films within the semiconducting region 110. Notably, the formation of the transparent electrode 115 is not part of the formation of the transistor, but rather part of the formation of a pixel that is controlled by the transistor. Formation of the transparent electrode 115 can include a patterned mask and deposition process. As such, the transparent electrode 115 can be formed via a deposition process, such as a thin film deposition process, and particularly using chemical vapor deposition (CVD), physical vapor deposition (PVD) (e.g., sputtering), atomic layer deposition (ALD), or any combination thereof.

Generally, the transparent electrode 115 is substantially transparent to a particular spectrum of radiation, such as visible light. Moreover, the transparent electrode 115 is particularly thin, and generally has an average thickness within a range between about 10 nm to about 100 nm. Moreover, the transparent electrode material is a conductive or semiconductive material, particularly a substantially transparent material. Suitable transparent, conductive or semiconductive materials can include oxides, such as metal oxides, and particularly indium tin oxide, often referred to as ITO.

After the formation of the transparent electrode 115, the process continues with the formation of source/drain regions for each of the gate electrodes. Referring to FIG. 1G, a cross-sectional view of the workpiece of FIG. 1F is illustrated after forming the source/drain portions 117. As will be appreciated, depending upon the method of forming, forming the source/drain portions 117 can include using a patterned mask and/or etching process to properly place the source/drain portions 117 in contact with the semiconducting layers 111 and 113 and the transparent electrode 115. The source/drain portions 117 can be formed via a deposition process, such as a thin film deposition process, and particularly using chemical vapor deposition (CVD), physical vapor deposition (PVD), atomic layer deposition (ALD), ion implantation, or any combination thereof.

The source/drain portions 117 generally includes a conductive material conventionally used in forming source/drain portions of semiconductor devices, such as a heavily doped semiconductor material or a metal-containing material, such as a metal oxide, a metal nitride, a metal-semiconductor material, a metal alloy, or any combination thereof. Particular dopant materials can include boron, arsenic, and phosphorous. According to one embodiment, the source/drain portions 117 include a metal such as aluminum, chromium, tantalum, tungsten, or alloys thereof. Typically, the source/drain portions 117 have an average thickness of not greater than about 500 nm, and particularly within a range between about 100 nm to about 300 nm.

Referring to FIG. 1H, after forming the source/drain portions 117 in FIG. 1G, formation of the bottom gate transistor can include formation of a passivation layer 119. According to one embodiment, the passivation layer 119 overlies the transistor structure (i.e., gate electrode 105, semiconducting layers 111 and 113, and source/drain portions 117) and a portion of the transparent electrode 115. The passivation layer 119 can be formed via a deposition process, such as a thin film deposition process, and particularly using chemical vapor deposition (CVD), physical vapor deposition (PVD) (e.g., sputtering) or combinations thereof.

The passivation layer 119 generally includes an insulating material. Particularly suitable insulating materials can include nitrides and oxides or combinations thereof. In one embodiment, the insulating layer includes a nitride, and particularly includes silicon nitride (SiNₓ). In another embodiment, the passivation layer 119 includes a combination of an oxide and nitride, and particularly can include SiOₓN_{y}. Typically, the average thickness of the passivation layer 119 is not greater than about 500 nm, and particularly within a range between about 100 nm to about 300 nm.

In addition to the substrate having the TFT array and pixels, a fully assembled LCD can include a separate substrate, particularly a color filter substrate. The color filter substrate includes a series of red, green, and blue sub-pixels on a glass substrate that is separate from the substrate containing the TFT array and pixels. Generally, the color filters can be made with either dyes or pigments. Formation of the color filters includes forming unit dots; each unit dot having a red, green, and blue sub-pixel to allow each unit dot the ability to form a spectrum of colors. Formation of the color filters can include utilizing coloring methods such as dyeing, diffusion, electro-deposition, and printing. Moreover, formation of the color filters on the color filter substrate can include formation of color resists, particularly one for each color, which are formed by patterned masks which can later be exposed and developed, using UV radiation, to define red, green, and blue sub-pixels. Additionally, a black resin can be used to fill voids between the sub-pixels to limit reflectivity and improve the color generated by the LCD.

Generally, after forming the unit dots, a protective film can be formed over the color filter layer. Such a protective film can include an oxide or nitride. Moreover, after the formation of the protective film, a transparent electrode can be formed using the same techniques and materials as was used to form the transparent electrode on the substrate containing the array of TFTs and pixels.

After formation of the TFT array substrate and the color filter substrate, the substrates can be scored and sectioned to appropriate sizes to form individual LCD panels. Each panel will include a TFT array panel and a color filter panel thus forming a LCD device. The panels can be joined together within a sealant such that the pixel regions on the TFT substrate and the color filter regions on the color filter substrate are aligned.

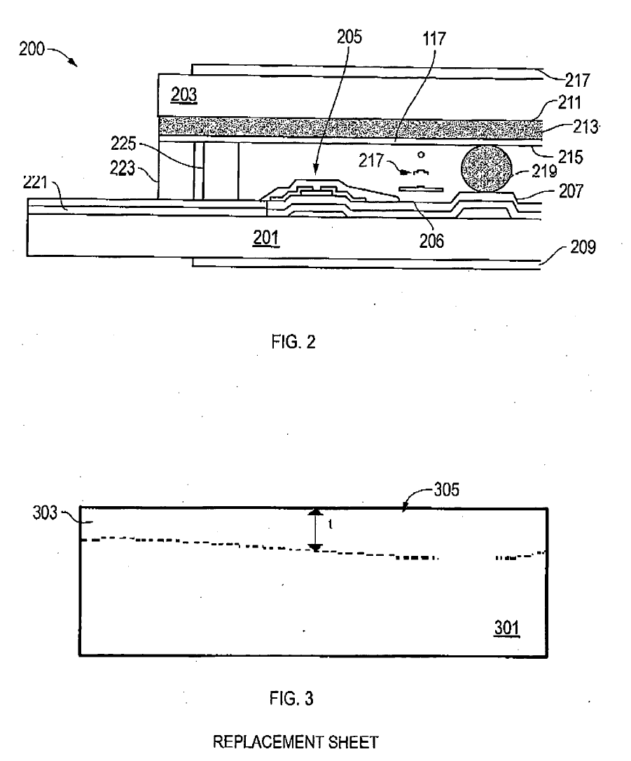

Referring to FIG. 2, a cross-sectional diagram of a portion of a LCD 200 is illustrated. The LCD 200 includes a TFT-array panel 201, including a TFT 205, a pixel electrode 206, a polarizer 209, and an alignment layer 207 overlying the TFT 205 and pixel electrodes 206. The TFT-array panel 201 can further include a bonding pad. The LCD 200 further includes a color filter panel 203 which includes a color filter 211 and a black matrix layer 213 underlying the color filter 211. The color filter panel 203 further includes a polarizer 217 overlying the color filter panels 203 and a transparent electrode 214 underlying the black filter. An alignment layer 215 underlies the transparent electrode 214, black matrix layer 213 and the color filter 211. The alignment layers 207 and 215 aid the alignment of the liquid crystals 217 between the panels 201 and 203 which in turn determines whether light is passing through the pixel.

The LCD 200 further includes liquid crystals 217 disposed between the panels 201 and 203 and particularly disposed in relation to the pixel region approximately defined by the transparent electrode 206 of the TFT-array panel 201. Spacers 219 are placed between the panels 201 and 203 at regular intervals to maintain the cell gaps and the space between the panels. Generally, these spacers 219 are sprayed onto the color filter panel 203. Moreover, the panels 201 and 203 are seal together via a seal 225, which can be cured with heat and pressure. The LCD further includes a short 223 contacting the TFT-array panel 201 and the color filter panel 203. It will be noted, that upon complete assembly of the LCD, typically the final step is to fill the voids between the panels 201 and 203 with liquid crystal material.

Referring to FIG. 3 a cross-sectional view of a portion of a monolithic article used for processing LCD articles, such as a stage or LCD glass substrate effector is illustrated according to one embodiment. As used herein, reference to a monolithic article 300 is intended to refer to a single and integral mass of material, which is typically formed as one piece. Generally, the monolithic article 300 can be formed using processes such as casting, molding, pressing, or extruding. For example, in the case of parts having complex shapes (e.g., LCD glass substrate effectors), or hollow components (e.g., tubes), slip casting may be used. While, components having less complex contours or solid structures (e.g., a LCD stage), may be formed by molding.

According to one embodiment, the monolithic article 300 includes a body portion 301 and a surface portion 303. Generally, the surface portion 303 includes at least a portion of the upper surface 305 but is not limited to the upper surface 305 and can extend a distance into the body portion 301, as illustrated in FIG. 3.

Notably, the monolithic article 300 includes an electrostatic dissipative material. As used herein, an electrostatic dissipative material includes a material that has a volume resistivity (Rᵥ) within a range between about 1.0×10⁵ Ωcm and about 1.0×10⁹ Ωcm. In one embodiment, the volume resistivity (Rᵥ) of the surface portion 303 is within a range between about 1.0×10⁶ Ωcm and about 1.0×10⁹ Ωcm.

As such, the monolithic article 300, and notably the surface portion 303 can include a material having such a volume resistivity. As will be appreciated, in embodiments utilizing a monolithic structure, while the surface portion and the body portion are described as distinct portions, such portions can include the same materials and properties. Accordingly, the surface portion 303, and in fact the body portion 301 for a monolithic stage, can include an inorganic material. Suitable inorganic materials can include carbides, nitrides, and oxides, or combinations or compound inorganic materials thereof. In one embodiment, the monolithic article 300 (i.e., the body portion 301 and the surface portion 303) includes a metal oxide, such as an oxide including a transition metal. Particularly suitable metal oxides, can include Al₂O₃, SiO₂, Cr₂O₃, MgO, ZrO₂, TiO₂, Y₂O₃, and Fe₂O₃, and combinations or complex compounds thereof.

According to one embodiment, suitable carbides can include silicon carbide. In one particular embodiment, the monolithic article 300 includes not less than about 20 vol % silicon carbide. Still, in another embodiment, the monolithic LCD article 300 includes not less than about 50 vol %, such as not less than about 75 vol % SiC, 95 vol %, or even not less than about 99.9 vol % SiC. According to one particular embodiment, the monolithic article 300 consists essentially of SiC.

According to another embodiment, the monolithic article 300 is a dense object, having little open or closed porosity. As such, the a porosity is generally not greater than about 5.0 vol %. In another embodiment, the porosity is less, such as not greater than about 2.0 vol %, not greater than about 1.0 vol %, or even not greater than about 0.5 vol %. Accordingly, the monolithic article 300 typically has a density of not less than about 90% of theoretical density. Other embodiments exhibit a greater density, such as not less than about 95%, or even not less than about 99% of the theoretical density of the material.

In addition to a dense material, the monolithic article 300 can be mechanically robust. Generally, the stiffness of the monolithic article 300 is not less than about 100 GPa. In one particular embodiment, the electrostatic dissipative monolithic article 300 has a stiffness of not less than about 150 GPa, such as not less than about 200 GPa, or even not less than about 300 GPa. In particular instances, the stiffness of the monolithic article 300 is not greater than about 500 GPa.

More particularly, the monolithic article 300 has a high specific stiffness, generally not less than about 50 GPa/cm³. In one particular embodiment, the specific stiffness is not less than about 60 GPa/cm³, not less than about 75 GPa/cm³, or even not less than about 100 GPa/cm³. Still, in certain embodiments, the specific stiffness is not greater than about 500 GPa/cm³.

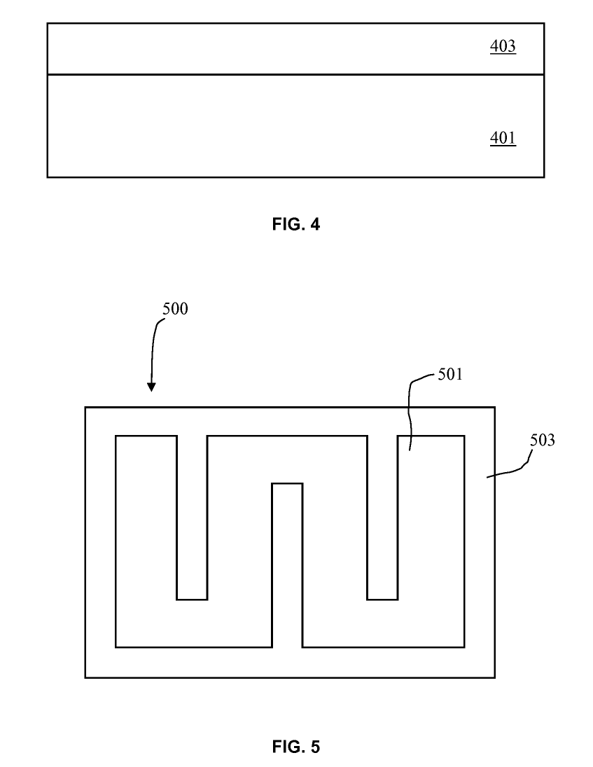

According to an alternative embodiment, the articles described herein can include separately formed portions (non-monolithic design), such that the surface portion is a distinctly formed portion (e.g., a skin portion) overlying the body portion, otherwise referred to as a substrate. Referring to FIG. 4, a cross-sectional view of an article 400 used for processing LCDs is provided which illustrates a substrate 401 and a skin portion 403 overlying the substrate 401. In one particular embodiment, the skin portion 403 is in direct contact with the substrate 401 and overlies not less than about 50% of the total surface area of the substrate 401. Still, the skin portion 403 can cover a greater amount of the substrate 401, such as not less than about 75%, or not less than about 90% of the total surface area of the substrate 401. In one particular embodiment, the skin portion 403 covers essentially the entire surface area of the substrate 401.

In such embodiments utilizing a stage having multiple components, that is, a substrate 401 and skin portion 403, the skin portion can be formed on the substrate as a reacted layer. In one such embodiment, the skin portion can be a grown layer, formed as a desired reaction between the surface of the substrate 401 and a reactant. The reactant may be provided in the atmosphere, such as for example, an atmosphere containing a high concentration of oxygen can be provided to form a reacted, oxidized layer.

Alternatively, the skin portion 403 can be a deposited layer formed via a deposition or spraying process. In one embodiment, the skin portion 403 is formed via a thin-film deposition process, such as a CVD, PVD, or ALD, or any combination thereof. In another embodiment, the skin portion 403 is formed via a spraying process, such as a thermal spraying process, and more particularly by a plasma spraying process or flame spraying process.

Moreover, formation of the skin portion 403 via a deposition process facilitates a doping procedure. Typically, the type of dopant depends upon the desired material of the skin portion 403, however, particularly suitable dopants can include metal elements, such as transition metal elements. In another embodiment, the skin portion 403 can include provision of a dopant containing an element from Group IIIA, IVA, VA, or VIA of the Periodic Table. In such embodiments, particularly suitable dopants include B and N. It is noted that dopant use may be limited due to contamination concerns.

The skin portion 403 generally has an average thickness of not less than about 5 microns, depending upon the method of forming. In one embodiment, the average thickness of the skin portion 403 is not less than about 10 microns, such as not less than about 20 microns, or even not less than about 30 microns. Still, the average thickness of the skin portion 403 is generally not greater than about 500 microns, and particularly within a range between about 10 to about 300 microns.

The skin portion 403 can include an electrostatic dissipative material having a volume resistivity (Rᵥ) within a range between about 1E6 Ωcm and about 1E11 Ωcm. In one embodiment, the volume resistivity (Rᵥ) of the skin portion 403 is within a range between about 1E6 Ωcm and about 1E9 Ωcm. Notably, the skin portion 403 can include the same materials, properties, and characteristics as those of the monolithic stage described above.

Accordingly, the skin portion can include an inorganic material, and more particularly, inorganic materials such as carbides, nitrides, and oxides, or combinations or compound materials thereof. In one particular embodiment, the skin portion 403 includes a metal oxide, such as an oxide including a transition metal. Particularly suitable metal oxides, can include Al₂O₃, SiO₂, Cr₂O₃, MgO, ZrO₂, TiO₂, Y₂O₃, and Fe₂O₃, and combinations or complex compounds thereof. Still, in another embodiment, the skin portion 403 can include SiC. Particular embodiments may utilize not less than about 20 vol % SiC, such as not less than about 75 vol % SiC, or even not less than about 95 vol % SiC in the skin portion 403.

The substrate 401 can include an inorganic material, ranging from natural materials such as stone, to fabricated materials such as a metals and metal alloys. Particularly suitable inorganic materials can include metals or ceramics, or combinations thereof. Suitable metals may include transition metals, light weight metals, or metal alloys. In one embodiment, the substrate 401 includes a metal such as aluminum, iron, chromium, steel, nickel, or combinations thereof. Particularly suitable ceramics can include oxides, nitride, or carbides. Suitable oxides can include metal oxides, particularly non-reactive and chemically stable oxides, such as for example, Al₂O₃, SiO₂, Cr₂O₃, MgO, ZrO₂, TiO₂, Y₂O₃, and Fe₂O₃.

Referring to FIG. 5, a top view of a stage 500 is illustrated according to one embodiment. Generally, the stage is used to support the glass substrate during the formation of the TFT array and other components making the final-formed LCD. Notably, the upper surface of the stage 500 is patterned having a raised portion 501 and a recessed portion 503. The patterned surface is illustrated as having a continues pattern such that the raised portion 501 extends in a continuous pathway along the upper surface of the stage 500. It will be appreciated, that the pattern demonstrated in FIG. 5 is illustrative and other patterns can be formed, such as a non-continuous pathways having irregular or polygonal patterns.

Generally, the raised portions 501 defining the pattern on the upper surface of the stage 500 comprise not less than about 30% of the total surface area of the upper surface. In another embodiment, the pattern covers not less than about 50%, such as not less than about 60%, or 75%, or even not less than about 80% of the total surface area of the upper surface.

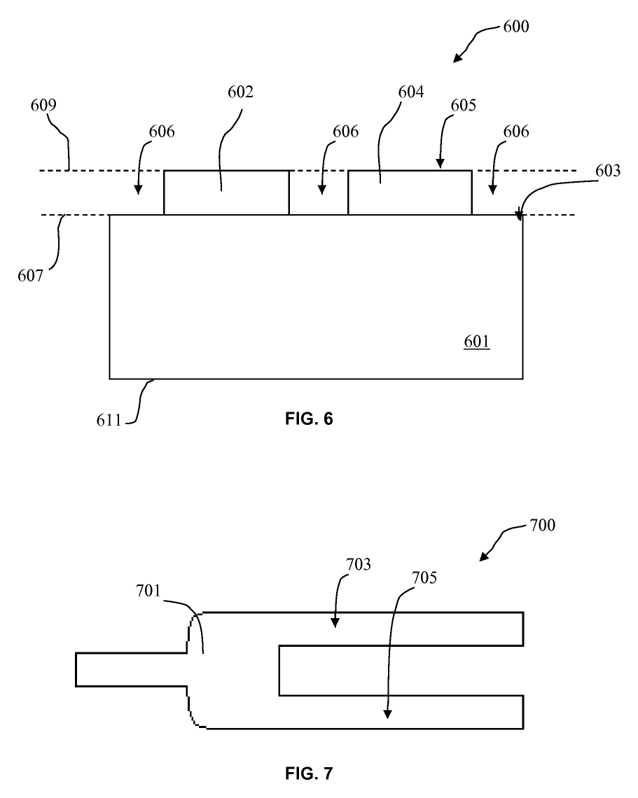

Referring to FIG. 6, a cross-sectional view of a portion of a stage 600 is illustrated. The stage 600 includes raised portions 602 and 604, which extend above the upper surface 603 and define recesses 606. As used herein, the working surface 605 is defined as the surface that makes contact with a workpiece. Accordingly, in embodiments utilizing an unpatterned surface, the upper surface and the working surface are the same. However, for embodiments utilizing a patterned surface having raised portions 602 and 604 and recesses 606, the working surface 605 is different than the upper surface 603 and the working surface 605 defines a working plane 609 that is different than the upper plane 607 defined by the upper surface.

Generally, the surface area of the working surface is not less than about 0.3 m². In one embodiment, the surface area of the working surface is not less than about 0.5 m², or not less than about 2.0 m², or even not less than about 4.0 m². Still, the surface area of the working surface is limited, such that it is typically not greater than about 25 m².

Notably, the working surfaces of the stages described herein have limited particle generation. Accordingly, the stages described herein include any combination of smooth working surfaces and dense structures, as structures which have rough, porous surfaces tend to generate particles which may damage the sensitive electrical components being formed. As such, generally the working surface is a smooth surface, having an average surface roughness (Rₐ) of not greater than about 200 microns. In one particular embodiment, the average surface roughness (Rₐ) is less, such as not greater than about 100 microns, or not greater than about 50 microns, or even not greater than about 10 microns. In particular, the average surface roughness (Rₐ) is within a range between about 100 microns and about 0.1 microns, and more particularly between about 1.0 micron and about 50 microns.

The working surface 605 of the stage 600 can have superior flatness as well. The flatness of a surface is typically understood to be the maximum deviation of a surface from a best-fit reference plane (see ASTM F 1530-02). In this regard, normalized flatness is a measure of the flatness of the surface normalized by the surface area on the generally planar surface, in this case the surface area of the working surface. According to one embodiment, the normalized flatness (nFlatness) of the generally planar surface is greater than about 10 μm/cm², such as not greater than about 5.0 μm/cm², or even not greater than about 1.0 μm/cm². Still, the normalized flatness of the generally planar surface can be less, such as not greater than about 0.5 μm/cm², or not greater than about 0.1 μm/cm². However, the normalized flatness of the generally planar surface is generally within a range between about 5.0 μm/cm² and about 0.01 μm/cm².

The stages provided herein, and particularly the working surfaces of such stages exhibit a reduced warping as characterized by normalized warp, hereinafter nWarp. The warp of a stage is generally understood to be the deviation of the median surface of the substrate from a best-fit reference plane (see ASTM F 697-92(99). In regards to the nwarp measurement, the warp is normalized to account for the surface area of the sapphire substrate. According to one embodiment, the nwarp is not greater than about 10 μm/cm², such as not greater than about 5.0 μm/cm², or even not greater than about 1.0 μm/cm².

The working surface can also exhibit reduced bow. As is typically understood, the bow of a surface is the absolute value measure of the concavity or deformation of the surface, or a portion of the surface, as measured from the substrate centerline independent of any thickness variation present. The working surface of stages provided herein exhibit a reduced normalized bow (nBow) which is a bow measurement normalized to account for the surface area of the working surface. As such, in one embodiment the nBow of the generally planar surface is not greater than about 10 μm/cm², such as not greater than about 5.0 μm/cm², or even not greater than about 1.0 μm/cm². According to another embodiment, the nBow of the substrate is within a range of between about 5.0 μm/cm² and about 0.1 μm/cm².

The stages provided herein can also exhibit superior parallelism. Parallelism is a measure of the average deviation in distance between two planes, and particularly the deviation in distance between a datum plane and a best fit plane of a selected surface. In reference to FIG. 6, the stages provided herein have a parallelism as measured between a bottom surface 611 and the working surface 605 of not greater than about 1000 μm. According to another embodiment, the parallelism is less, such as not greater than about 500 μm, or not greater than about 100 μm.

FIG. 7 includes a perspective view of a LCD glass substrate effector in accordance with one embodiment. The effector 700 illustrated is a handler configured to engage and support a LCD glass substrate in transport, such as to or from a stage. As illustrated, the effector 700 can be formed such that it includes a body 701 including arm portions 703 and 705. In particular embodiments as illustrated, the arm portions 703 and 705 can extend from the body in a direction such that they are substantially parallel to each other giving the effector a shape of a fork.

As such, the arm portions 703 and 705 can have a length, width, and thickness, suitable for carrying large LCD glass substrates between tools and onto stages, wherein the length≧width≧thickness. As such, in one particular embodiment, the length of the arm portions 703 and 705 is not less than about 0.5 m, such as not less than about 1 m, not less than about 1.5 m and within a range between about 0.5 m and about 3 m. Moreover, the thickness of the arm portions 703 and 705 are such that they are particularly thin, despite the weight of the massive LCD glass substrates. In one embodiment, the arm portions 703 and 705 have a thickness that is not greater than about 20 cm, such as not greater than about 15 cm, not greater than about 10. In accordance with certain embodiments, the thickness of the arm portions 703 and 705 are within a range between about 1 cm and about 20 cm, and more particularly within a range between about 2 cm and about 15 cm.

As mentioned above, the effector illustrated in FIG. 7 is a handler, facilitating the transport of large glass substrates between processing tools and on and off stages, particularly in the context of LCD manufacturing environments. Such effectors are lighter, and particularly designed for operation with sensitive LCD glass substrates, notably having limited particle generation and ESD dissipative capabilities. In accordance with one embodiment, the effector facilitates transport of an LCD glass substrate from a holding surface to a stage for processing of the substrate. Additionally, the effector can be used for additional transport of the LCD glass substrate through the manufacturing process, including after processing the TFT on the LCD glass substrate and positioning of the LCD glass substrates for manufacturing of the final-formed LCD article.

The effector 700 can be a monolithic LCD processing article having those features and characteristics as described above in accordance with FIG. 3. For example, the effector body 701 can be made of an electrostatic dissipative material having volume resistivity (Rᵥ) within a range between about 1.0×10⁵ Ωcm and about 1.0×10⁹ Ωcm. And more particularly, the arm portions 703 and 705 that are used to directly contact the LCD glass substrate, can include an ESD dissipative material.

Alternatively, the effector 700 can include multiple component layers, such as a substrate 401 and a skin portion 403 formed and having those features and characteristics described herein in accordance with FIG. 4. In such embodiments, the skin portion 403 can cover the body 701 and include an ESD dissipative material. Certain embodiments may utilize a skin portion 403 on the arm portions, and in particular embodiments, the effector 700 can be formed such that the skin portion 403 is only overlying the arm portions 703 and 705.

The working surface of the effector 701, that being the upper surfaces designed to contact the LCD glass substrate, are primarily the upper surfaces of the arm portions 703 and 705. As such, the working surface of the effector 700 can have the same geometric characteristics as previously described in accordance with the stage of FIGS. 5 and 6, including for example surface roughness, flatness, warp, bow, and parallelism. The working surface of the effector 700, like the stage 500, also has limited particle generation characteristics suitable for reducing potential contamination to the LCD articles.

### EXAMPLES

### Example 1

An electrostatic dissipative monolithic stage for forming LCD articles thereon is made using the following process. Initially, an equal mixture of 12 micron and 4 micron SiC powder is mixed with 20 wt % water to form a slurry which is processed in an attrition mill. The slurry is then treated with an acid solution containing equal parts HNO₃ and HF acids. After 8 hours in the agitated acid treatment tanks, the slurry is diluted with DI water to decant the supernatant and the settled species is filter pressed to remove the water. The resulting filter cake exhibits about 72 wt % solids content.

The filter cake is refluidized with water such that it has a solids content of about 60 wt %. After refluidizing, an addition of concentrated NH₄OH solution is provided to shift the pH above 8 which facilitates electrostatic dispersion. The slurry is milled, particularly using a vibration mill with 10 mm SiC media, along with a 0.64 wt % addition of submicron B₄C and is milled for a minimum of 8 hours, until a mean particle size of 0.48 microns is achieved.

The resulting slurry is mixed with 2.8 wt % phenolic resin and 3.0 wt % of both poly-vinyl alcohol and acrylic resin. The mixture is then spray dried to achieve a granules having a target nodule size of approximately 75 microns.

After spray drying, the granulate is dry pressed and cured at 250° C. for a duration of 2 hours forming a green-state (i.e., unfired) stage. The green-state stage is fired at 2250° C. in a nitrogen atmosphere for a 4 hour soak time. The working surface of the stage were cleaned via grinding or sand blasting to remove excess carbon and provide the geometric features (e.g., surface roughness) described above. Grinding was completed using 320 grit. The density of the resulting is 3.15 g/cc, and the porosity is less than 2.0 vol %, and the volume resistivity is 5.0E9 Ωcm.

### Example 2

An electrostatic dissipative stage having a layered structure for forming LCD articles thereon is made using the following process. A mixture containing 10.5 wt % water, 43.0 wt % 100F SiC (d₅₀=150 microns), and 46.5 wt % fine SiC (d₅₀=3 microns) is blended at pH of 7.8. The pH is adjusted using a 25% solution of NaOH to achieve the pH, and the mixture is processed in a rolling mill for a minimum of 4 hours for suitable dispersion and homogeneous mixing. Latex is then added to the mix at a concentration of 0.2% by weight.

The resulting bimodal slurry is cast into a Plaster of Paris mold incorporating a cavity having roughly the desired stage dimensions. When consolidation is complete, the part is stripped from the mold and dried at 60° C. for a minimum of 8 hours to form a green article. After drying, the green article is fired at a temperature of 2450° C. in an argon atmosphere with a soak time of 8 hours.

After firing the green article, the stage is coated with a layer of plasma sprayed Cr₂O₃ which forms a skin layer having an average thickness of 150 microns. This resulted in closing the porosity at the surface, making the article smoother and more dense. The resulting volume resistivity (Rᵥ) of the electrostatic dissipative skin layer is 2.4E7 Ωcm.

### Comparative Example 1

A monolithic stage for forming LCD articles thereon is made using the following process. The process for forming the stage in Example 2 is followed except that after firing the article is not spray coated with a layer of Cr₂O₃. The resulting product had a density of 2.75 g/cc, 15 vol % porosity, and a volume resistivity (Rᵥ) of 2.0E3 Ωcm.

### Comparative Example 2

A stage having a layered structure for forming LCD articles thereon is made using the following process. The process for forming the stage in Comparative Example 1 is followed, but after firing the green article, the fired article is coated with a layer of chemically vapor deposited (CVD) silicon carbide to form a skin layer over the substrate. The skin layer has an average thickness of 150 microns. This resulted in closing the porosity at the surface of the substrate, making the article smoother and more dense. The volume resistivity of the skin layer of the layered stage is 1.0E2 Ωcm.

Referring now to FIGS. 8-10, plots are provided that illustrate the volume resistivity over a range of voltages for 17 samples made in accordance with the process of Example 1, including grinding with 320 grit to remove approximately 200 microns of material from the surface.2. Each of the samples were measured using a Keithley 6517A Electrometer (S/N 0776902) with Keithley Model 6524 software (Hi-R test), using two, 2.54 cm diameter conductive rubber contacts in direct contact with the samples and connected to two 2.54 cm diameter electrodes.

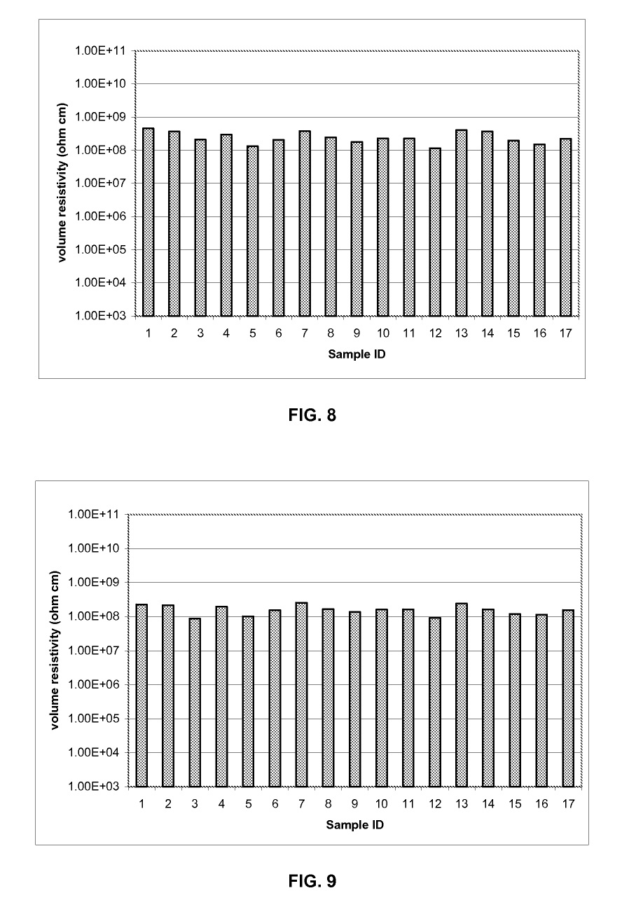

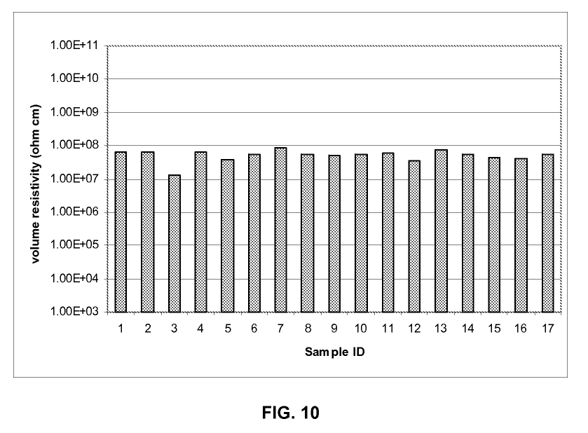

In particular, FIGS. 8-10 illustrate the volume resistivity for 17 samples measured at different voltages, wherein the plot of FIG. 8 illustrates the volume resistivity of the 17 samples measured at an applied voltage of 1 V, FIG. 9 illustrates the volume resistivity of the same 17 samples measured at an applied voltage of 10 V, and FIG. 10 illustrates the volume resistivity of the 17 samples measure at an applied voltage of 100V. The samples had resistivities within a range between 1E7 Ohm cm and 5E8 Ohm cm across the range of applied voltages, demonstrating consistent volume resistivity values suitable for ESD dissipative applications. Moreover, the samples had superior resistivity capabilities over a range of applied voltages, demonstrating the capability for dissipating electrostatic discharges occurring over a wide range of voltages.

While the invention has been illustrated and described in the context of specific embodiments, it is not intended to be limited to the details shown, since various modifications and substitutions can be made without departing in any way from the scope of the present invention. For example, additional or equivalent substitutes can be provided and additional or equivalent production steps can be employed. As such, further modifications and equivalents of the invention herein disclosed may occur to persons skilled in the art using no more than routine experimentation, and all such modifications and equivalents are believed to be within the scope of the invention as defined by the following claims.

1. A process for producing a liquid crystal display (LCD) comprising:
placing a glass substrate on a stage, the stage being electrostatic discharge (ESD) dissipative and having a surface portion that has a volume resistivity (Rᵥ) within a range between about 1E5 Ωcm and about 1E11 Ωcm; and
subjecting the glass substrate to at least one processing operation of a plurality of processing operations for forming an array of electronic devices on the glass substrate.

2-3. (canceled)

4. The process of claim 1, wherein the stage comprises a substrate and the surface portion is in the form of a skin portion overlying the substrate.

5. (canceled)

6. The process of claim 4, wherein the skin portion is formed via a film deposition process.

7. The process of claim 6, wherein the film deposition process includes a process selected from the group of processes consisting of chemical vapor deposition, plasma vapor deposition, thermal spraying, and plasma spraying.

8-10. (canceled)

11. The process of claim 1, wherein the array of electronic devices comprises an array of thin film transistors,

12. The process of claim 1, wherein the at least one processing operation comprises a deposition process.

13. The process of claim 12, wherein the deposition process comprises a thin-film deposition process selected from the group of processes consisting of chemical vapor deposition (CVD), physical vapor deposition (PVD), and atomic layer deposition (ALD).

14-16. (canceled)

17. The process of claim 1, wherein the at least one processing operation includes forming a color filter on the glass substrate

18. The process of claim 1, wherein the at least one processing operation includes sectioning the glass substrate

19. The process of claim 1, wherein the at least one processing operation includes forming a transparent electrode.

20. A LCD stage comprising:
a body comprising a surface portion, the surface portion being an electrostatic discharge (ESD) diccipative material having a volume resistivity (Rᵥ) within a range between about 1E5 Ωcm and about 1E11 Ωcm.

21. (canceled)

22. The LCD stage of claim 20, wherein the body comprises a substrate and the surface portion is in the form of a skin portion.

23. The LCD stage of claim 22, wherein the skin portion is in direct contact with the substrate.

24-25. (canceled)

26. The LCD stage of claim 22, wherein the skin portion comprises silicon carbide.

27. The LCD stage of claim 20, wherein the surface portion comprises an upper surface.

28. The LCD stage of claim 27, wherein the upper surface comprises a pattern defined by raised portions above recessed portions, wherein the raised portions define a working surface.

29-30. (canceled)

31. The LCD stage of claim 28, wherein the working surface has an average surface roughness (Rₐ) of not greater than about 200 microns.

32. (canceled)

33. The LCD stage of claim 28, wherein the body comprises a bottom surface defining a bottom plane opposite the working the plane.

34. The LCD stage of claim 33, wherein the body comprises a parallelism between the working surface and the bottom surface of not greater than about 1000 μm.

35-40. (canceled)

41. A method of transporting a glass substrate for LCD processing comprising:
placing a glass substrate on an effector, the effector comprising a body having an arm portions extending from the body, the body having a surface portion being an electrostatic discharge (ESD) dissipative material having a volume resistivity (Rᵥ) within a range between about 1E5 Ωcm and about 1E11 Ωcm; and
transporting the glass substrate from a first position to a second position using the effector.

42. The method of claim 41, wherein the body comprises at least two arm portions extending from the body configured to engage the glass substrate.

43. (canceled)

44. The method of claim 41, wherein the arm portion is configured to support the LCD glass substrate.

45. (canceled)

46. The method of claim 45, wherein the body comprises a substrate and the surface portion is in the form of a skin portion.

47. The method of claim 46, wherein the skin portion is in direct contact with the LCD glass substrate.

48-49. (canceled)

50. The method of claim 46, wherein the skin portion comprises silicon carbide.

51-57. (canceled)
